(19) United States
(12) Patent Application Publication
(10) Pub. No.: US 2009/0094726 A1
(43) Pub. Date: Apr. 16, 2009

(54) Composite structure for protective garment

(75) Inventors: William L. Grilliot, Dayton, OH (US); Mary I. Grilliot, Dayton, OH (US); William L. Grilliot, JR., Dayton, OH (US)

Correspondence Address: WOOD, PHILLIPS, KATZ, CLARK & MORTIMER, 500 W. MADISON STREET, SUITE 3800, CHICAGO, IL, 60661, US

(73) Assignee: Morning Pride Manufacturing, L.L.C.

(21) Appl. No.: 11/973,863

(22) Filed: Oct. 10, 2007

(51) Int. Cl. A62B 17/00; A41D 1/00; A41D 3/02

(52) U.S. Cl. 2/81; 2/69; 2/93; 2/97

(57) ABSTRACT

A protective garment (10) for a firefighter or other emergency worker includes an outer shell (20), at least one of a moisture barrier layer or a thermal insulative layer (22 or 24) and a liner (26) that includes 85% to 95% by weight hydrophobic fibers and 15% to 10% by weight hydrophilic fibers.

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD OF THE INVENTION

This invention pertains to a composite structure for a protective garment for use by a firefighter or other emergency worker, such as a pair of bunker pants for a firefighter, a bunker coat for a firefighter, or a glove for a firefighter.

### BACKGROUND OF THE INVENTION

Commonly, in a firefighting or other emergency environment, a firefighter wearing protective garments, such as bunker pants, a bunker coat, and gloves, sweats copiously within such garments, whereby the firefighter is exposed to severe stresses due to sweating, as well as to severe stresses due to firefighting. Such stresses are known to contribute significantly to fatigue, injuries, and fatalities among firefighters.

### SUMMARY OF THE INVENTION

In accordance with one feature of the invention, a protective garment is provided for use by a firefighter or other emergency worker. The protective garment includes an outer shell, at least one of a moisture barrier layer or a thermal insulative layer within the outer shell; and a liner within the at least one of a moisture barrier layer or thermal insulative layer, the liner includes 85% to 95% by weight hydrophobic fibers and 15% to 10% by weight hydrophilic fibers.

As one feature, the hydrophobic fibers include a polymer and the hydrophilic fibers include cellulosic fibers. As a further feature, the polymer includes modacrylic fibers and the cellulosic fibers comprise lyocell fibers.

According to one feature, the at least one of a moisture barrier layer or thermal insulative layer is a moisture barrier liner.

In one feature, the at least one of a moisture barrier layer or thermal insulative layer is a thermal insulative liner.

In accordance with one feature of the invention, a protective garment is provided for use by a firefighter or other emergency worker. The protective garment includes an outer shell, and a liner including 85% to 95% by weight hydrophobic polymer fibers and 15% to 10% by weight hydrophilic cellulosic fibers.

As one feature, the hydrophobic polymer fibers comprise modacrylic fibers, and the hydrophilic cellulosic fibers comprise lyocell fibers.

In accordance with one feature of the invention, a protective garment is provided for use by a firefighter or other emergency worker. The protective garment includes an outer shell, and a liner including 85% to 95% by weight modacrylic fibers and 15% to 10% by weight lyocell fibers.

In one feature, the protective garment of further includes a moisture barrier liner within the outer shell.

According to one feature, the protective garment further includes a thermal insulative liner within the outer shell.

Other objects, features, and advantages of the invention will become apparent from a review of the entire specification, including the appended claims and drawings.

### BRIEF DESCRIPTION OF THE DRAWINGS

FIG. 1 is a perspective view from the side of a firefighter or other emergency worker wearing protective garments embodying the present invention; and

FIG. 2 is a section view taken along any of the section lines 2-2 in FIG. 1 and showing a composite structure for the protective garments of FIG. 1.

### DETAILED DESCRIPTION OF THE PREFERRED EMBODIMENT

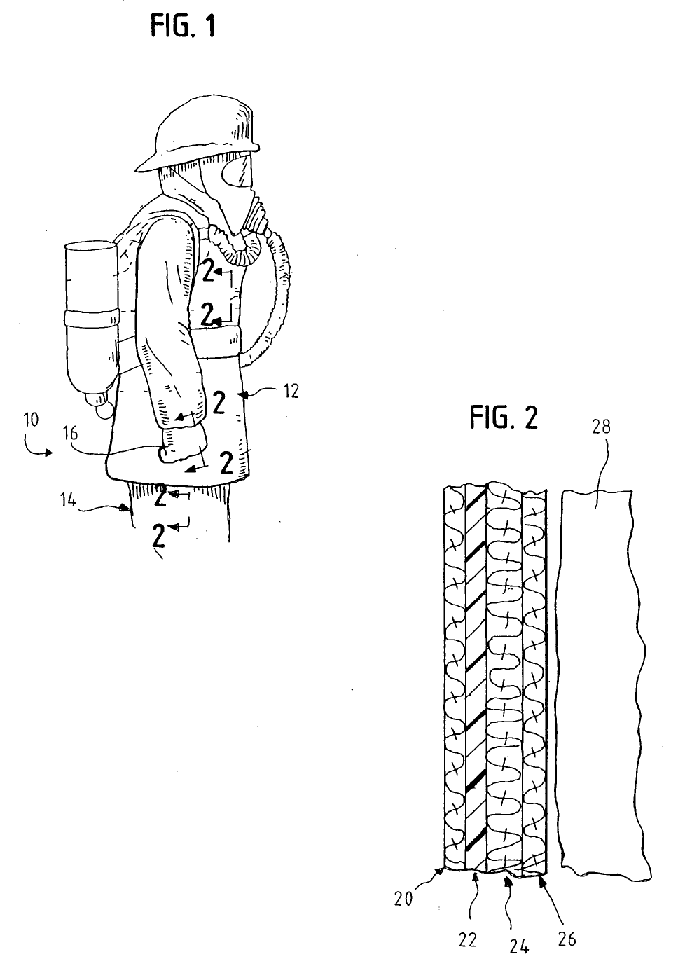

With reference to FIG. 1, a firefighter or other emergency worker is shown wearing protective garments 10 in the form of a bunker coat 12, a pair of bunker pants 14, and a glove 16. The general construction of such garments is known, and is shown, for example, in U.S. Pat. No. 6,658,670, issued Dec. 9, 2003 to Grilliot et al and U.S. Pat. No. 6,806,215, issued Oct. 19, 2004 to Grilliot et al, the entire disclosures of which are incorporated herein by reference.

With reference to FIG. 2, it can be seen that each of the protective garments is a multilayered construction consisting of an outer shell 20, a moisture barrier layer, shown in the form of a moisture barrier liner 22; a thermal insulating layer, shown in the form of a thermal insulating liner 24; and a moisture management layer in the form of a liner 26 that is preferably the innermost liner of the garment lying closest to the wearer's body 28. It should be appreciated that while the moisture barrier and thermal insulating layers are shown in the form of liners, other constructions are possible. For example, the moisture barrier layer could be in the form of a coating applied to the outer shell 20 or to the thermal insulating liner 24. It should also be appreciated that while it is preferred that the liners 22 and 24 be removable as separate components, in some applications it may be desirable for the liners 22 and 24 to be integrated with the outer shell 20 and/or with each other, such as by sewing or otherwise attaching or bonding the liners 22 and 24 to the outer shell 20 and/or to each other.

Each of the layers 20, 22 and 24 can be made from any suitable fabrics, many of which are known, for each of their particular functions. For example, the outer shell 20 can be made from any suitable fire resistant, thermal resistant, and/or wear resistant (i.e., resistant to cuts, snags, tears and abrasions) material, some examples of which include Kevlar®, Nomex®, Basofil, PBI (polybenzimidazole), and PBO (poly(p-phenylenebenzobisoxazole)) materials. The thermal insulating liner 24 can be made of a suitable thermal insulating material or construction, such as nonwoven batting, closed cell foam, and Basofil/Aramid batting sandwiched between face layers of a suitable breathable fabric. The moisture barrier 22 can be any suitable material that is highly resistant to the passage of liquid, particularly liquid water, such as, for example, neoprene, the fabric supplied by W. L. Gore & Associates, Inc. under the CROSSTECH® trademark and/or a material that is also highly resistant to chemicals so that it also acts as a chemical barrier, such as for example, the material supplied by W. L. Gore & Associates, Inc. under the CHEMPAK® trademark.

The moisture management liner 26 is constructed from 85% to 90% by weight hydrophobic fibers and 15% to 10% by weight hydrophilic fibers. Preferably, the hydrophobic fibers are a polymer, and even more preferably, the hydrophobic fibers are a modacrylic fiber. The hydrophilic fibers are preferably cellulosic fibers, and even more preferably, the hydrophilic fibers are lyocell fibers, one suitable type of which is supplied by the Lenzing Group under the TENCEL® trademark. Additional examples of suitable fabrics for the liner 26 can be found in U.S. Pat. No. 5,888,914, issued Mar. 30, 1999 and naming Manfred Katz as the inventor, the entire disclosure of which is incorporated herein by reference.

While a preferred construction has been shown, it should be appreciated that other embodiments are impossible. For example, in some applications it may be advantageous for one or both of the layers 22 and 24 to be removed or eliminated from the garment 10. As another example, in some applications, it may be advantageous or desirable for the liner 26 to be positioned between two of the layers 20, 22 and 24, rather than positioned as the innermost layer of the garment 10.

1. A protective garment for use by a firefighter or other emergency worker, the protective garment comprising:
an outer shell;
at least one of a moisture barrier layer or a thermal insulative layer within the outer shell; and
a liner within the at least one of a moisture barrier layer or thermal insulative layer, the liner comprising 85% to 95% by weight hydrophobic fibers and 15% to 10% by weight hydrophilic fibers.

2. The protective garment of claim 1 wherein the hydrophobic fibers comprise a polymer and the hydrophilic fibers comprises cellulosic fibers.

3. The protective garment of claim 2 wherein the polymer comprises modacrylic fibers and the cellulosic fibers comprise lyocell fibers.

4. The protective garment of claim 1 wherein the at least one of a moisture barrier layer or thermal insulative layer is a moisture barrier liner.

5. The protective garment of claim 1 wherein the at least one of a moisture barrier layer or thermal insulative layer is a thermal insulative liner.

6. A protective garment for use by a firefighter or other emergency worker, the protective garment comprising:
an outer shell; and
a liner comprising 85% to 95% by weight hydrophobic polymer fibers and 15% to 10% by weight hydrophilic cellulosic fibers

7. The protective garment of claim 6 wherein the hydrophobic polymer fibers comprise modacrylic fibers, and the hydrophilic cellulosic fibers comprise lyocell fibers.

8. The protective garment of claim 6 further comprising a moisture barrier liner within the outer shell.

9. The protective garment of claim 6 further comprising a thermal insulative liner within the outer shell.

10. A protective garment for use by a firefighter or other emergency worker, the protective garment comprising:
an outer shell; and
a liner comprising 85% to 95% by weight modacrylic fibers and 15% to 10% by weight lyocell fibers.

11. The protective garment of claim 10 further comprising a moisture barrier liner within the outer shell.

12. The protective garment of claim 10 further comprising a thermal insulative liner within the outer shell.
